(19) United States
(12) Patent Application Publication
(10) Pub. No.: US 2025/0229460 A1
(43) Pub. Date: Jul. 17, 2025

(54) Apparatus and method for treating plastics material preforms with temperature detection

(71) Applicant: KRONES AG, Neutraubling (DE)

(72) Inventors: Markus ZOELFL, Metten (DE); Daniel PETER, Hemau (DE)

(21) Appl. No.: 19/022,115

(22) Filed: Jan. 15, 2025

(30) Foreign Application Priority Data
Jan. 15, 2024 (DE) 10 2024 101 052.5

(51) Int. Cl. B29B 13/02; B29C 49/64; B29C 49/78

(52) U.S. Cl. CPC B29B 13/024; B29C 49/6418; B29C 49/78; B29C 2049/7862; B29C 2049/78805

(57) ABSTRACT

An apparatus for treating plastics material preforms has a transport device which transports the plastics material preforms along a predetermined transport path, at least one heating unit to heat the transported plastics material preforms, and a forming device arranged downstream of the heating device for forming the heated plastics material preforms into plastics material containers. The apparatus has at least one temperature detection device for detecting to detect a temperature of the plastics material preforms heated by the heating device, in a spatially resolved manner at least in a longitudinal direction of the plastics material preforms, and an image recording device to record a spatially resolved image of the plastics material preforms, wherein the image recording device is configurable taking into account at least one parameter characteristic of the plastics material preforms to be inspected.

### BACKGROUND OF THE INVENTION

The present invention relates to an apparatus and a method for treating plastics material preforms. Such apparatuses and methods have long been known from the prior art. Usually, plastics material preforms are heated in an oven in order then to be formed into plastics material containers and, in particular, plastics material bottles in this heated state.

The temperature of the plastics material preforms at the exit of the oven is a substantial parameter for the production or the forming process. From the applicant's internal prior art, it is known to use pyrometers at the oven or at the exit of the oven, which pyrometers detect the temperature of the plastics material preforms. The distance of the individual measuring points is fixed, since the pyrometers are attached to the frame. It can therefore happen that, in the case of a very small or short plastics material preform, the lowest pyrometers cannot detect any values that are characteristic of the plastics material preforms.

It is known from DE 10 2016 118 670 B1 that, after the manufacture of plastics material preforms, the temperature distribution on the surface of the plastics material preforms is determined by a thermal imaging camera.

WO 20211071677 A1 describes that certain substantial regions are determined using a detector.

EP 4 051 484 B1 describes that the quality of a container is determined based on a thermal image. In this case, it is checked whether a value in a critical zone is below a threshold value.

The object of the present invention is to improve temperature monitoring of such plastics material preforms.

### SUMMARY OF THE INVENTION

Preferred embodiments are the subject matter of the dependent claims.

An apparatus according to the invention for treating plastics material preforms has a heating device which is suitable and intended to heat the plastics material preforms, wherein the heating device has a transport device which transports the plastics material preforms along a predetermined transport path, and at least one heating unit which is suitable and intended to heat the plastics material preforms transported by the transport device.

Furthermore, the apparatus has a forming device, which is arranged downstream of the heating device in a transport direction of the plastics material preforms and which is suitable and intended to form the plastics material preforms heated by the heating device into plastics material containers, wherein the apparatus has at least one temperature detection device which is suitable and intended to detect a temperature of the plastics material preforms heated or to be heated by the heating device, wherein the temperature of the plastics material preforms can be detected in a spatially resolved manner at least in a longitudinal direction and/or in a circumferential direction of the plastics material preforms.

According to the invention, the temperature detection device has an image recording device which is suitable and intended to record at least one spatially resolved image of the plastics material preforms or of a portion of the plastics material preforms, wherein the image recording device is configurable and, preferably, is configurable taking into account at least one parameter characteristic of the plastics material preforms to be inspected.

It is therefore proposed that an image recording device and, in particular, a thermal imaging camera is used instead of the pyrometers provided in the prior art. Particularly preferably, the image recording device is suitable and intended to acquire radiation in the infrared wavelength range.

Within the image region of the thermal imaging camera, it is preferably possible to configure and/or select regions or sections which in turn preferably correspond to the previously used, for example nine, positions of a pyrometer system. In particular, it is possible to select regions from an image recorded by the image recording device, which regions are analyzed as part of an image analysis.

As explained in detail below, the selected region can also be a line, an image section, or several image sections.

A key advantage is that the regions can be selected independently of the positioning of the image recording device, for example a camera. In the prior art, if a focus is to be placed on the actual size of the plastics material preform, the region to be detected must be set and/or configured separately for each customer object and for each machine.

Particularly preferably, the heating device is a heating device which heats the plastics material preforms by infrared radiation. It would also be possible to use a heating device which heats the plastics material preforms by microwaves or by other types of radiation.

Particularly preferably, the heating device has a rotating device, which rotates the plastics material preforms about their own longitudinal direction during their heating. Particularly preferably, the image recording device records the images during a rotation of the plastics material preforms (with respect to their longitudinal direction).

It is possible that the images are recorded using a specified exposure time. This exposure time can be so short that the plastics material preform does not rotate or practically does not rotate or only rotates by a negligible angle during the exposure time. Preferably, an exposure time is less than 1/50s, preferably less than 1/100s, preferably less than 1/200s, preferably less than 1/400s, preferably less than 1/500s, preferably less than 1/800s, and preferably less than 1 ms.

Particularly preferably, the heating units of the heating device are arranged to be stationary and, preferably, the plastics material preforms are transported past these heating units. Preferably, the heating units each have a plurality of heat emitters, which extend in the transport direction of the plastics material preforms.

With a further advantageous embodiment, the transport device has holding devices for holding the plastics material preforms and, in particular, the transport device has holding mandrels for holding the plastics material preforms, which holding mandrels can be inserted into the mouths of the plastics material preforms. Preferably, the heating device transports the plastics material preforms at a (in particular constant) distance from one another. Preferably, the transport device is suitable and intended to transport the plastics material preforms at least in portions along a straight transport path portion.

Particularly preferably, the downstream forming device is a blowing machine and, in particular, a stretch blowing machine. Particularly preferably, this forming device has a movable and, in particular, rotatable carrier on which a plurality of forming stations is arranged. These forming stations preferably each have blow molds within which the plastics material preforms can be formed into plastics material containers and, in particular, plastics material bottles.

Particularly preferably, the apparatus has an ejection device which is suitable and intended to eject plastics material preforms, transported by the transport device or a downstream transport device, from the transport path of the plastics material preforms. In particular, these are faulty plastics material preforms or plastics material preforms that have been identified by the temperature detection device as faulty or as having a faulty temperature profile. In particular, the ejection device is suitable and intended to eject and/or discharge plastics material preforms from the transport path of the plastics material preforms in response to a signal from the temperature detection device.

In a further preferred embodiment, the apparatus has a production apparatus for manufacturing the plastics material preforms. Preferably, this production apparatus is arranged upstream of the heating device in the transport direction of the plastics material preforms. Preferably, the production device is an injection molding machine or an injection-compression molding machine.

In a particularly preferred embodiment, the image recording device is a camera and, in particular, a thermal imaging camera or an infrared camera. It is possible that this camera is arranged to be stationary. However, it is in particular preferred that the camera can change the observation portion, at least the observation portion to be analyzed. In addition, it would also be possible for the image recording device to be movable, for example pivotable, in order to facilitate image recording of plastics material preforms of different lengths.

A configurable image recording device is in particular understood to mean that at least one parameter characteristic of the image recording and/or image analysis of the images recorded by this image recording device is changeable. It would be possible for an image recording range of the image recording device to be changeable, for example a zoom range of the camera. However, it would also be conceivable that the region of a recorded image that is analyzed is changeable.

However, as mentioned above, it can particularly preferably be configured and/or selected which portion(s) of the image recorded by the image recording device are to be analyzed.

Particularly preferably, the apparatus has a second temperature detection device and/or a second image recording device, which is in particular arranged upstream of the aforementioned first temperature detection device. This second temperature detection device and/or image recording device can, for example, detect at least one value that is characteristic of a geometry of the plastics material preforms.

A spatially resolved temperature detection is in particular understood to mean that, at at least two, preferably at least three and particularly preferably at least four different points or regions of the plastics material preform, a temperature or its temperature is detected. In particular, a temperature is detected in at least two points or regions of the plastics material preform in its longitudinal direction. Particularly preferably, the temperature of the plastics material preforms (or a value characteristic of this temperature) is detected in at least three, preferably in at least four, preferably in at least five, preferably in at least six, preferably in at least seven, particularly preferably in at least eight points and/or regions. It is possible that these points or regions are equidistant from one another.

It is possible for the temperature detection device to detect the temperature of the plastics material preforms quantitatively, but it would also be possible for the temperature to be detected qualitatively, for example by identifying colder and warmer regions of the plastics material preform on the basis of a recorded image.

In a preferred embodiment, the apparatus has a control device for controlling the forming device and this control device is suitable and intended to control the forming device depending on a temperature of a plastics material preform that is detected by the temperature detection device.

In this configuration, it is therefore proposed that the forming process, such as a blow molding process, is also controlled depending on the temperature distribution detected by the temperature detection device. For example, the application of a gaseous medium to the plastics material preforms, the movement of a stretching rod, and the like can be controlled depending on the detected temperature.

In a further advantageous embodiment, the apparatus has an assignment device which is suitable and intended to assign a specific plastics material preform which temperature has been detected, to a forming station, which will form this plastics material preform.

In a further advantageous embodiment, the image recording is configurable and, preferably, the image recording device is configurable taking into account at least one parameter characteristic of the plastics material preforms to be inspected.

In a preferred embodiment, this characteristic parameter is selected from a group of parameters, which contains a length of the plastics material preform, an outer cross-section of the plastics material preform, an inner cross-section of the plastics material preform, a wall thickness of the plastics material preform, a material of the plastics material preform, and the like.

It is thus possible to determine, in a first step, values that are characteristic of the plastics material preform(s), such as a geometry, a recycled content, a weight, additives used in injection molding, and the like. These characteristic values can, for example, be determined using an upstream camera system or using an upstream camera or using the thermal imaging camera described here or the image recording device itself.

In a further preferred embodiment, the apparatus has an analysis device and, in particular, an image analysis device which is suitable and intended to analyze the images recorded by the image recording device, wherein the analysis device is preferably configurable and, in particular, is configurable with regard to a region to be analyzed of an image recorded by the image recording device.

An image analysis can thus take place and, for example, the geometry of the plastics material preform can be derived on the basis of the image. Alternatively or additionally, it is however conceivable that a machine operator enters the characteristic values in advance. In a second step, it is possible to pass the previously determined characteristic values to a control device.

The apparatus therefore preferably has a control device which is suitable and intended to control the image recording device and/or the analysis of the images recorded by the image recording device.

The control device can then determine a plastics material preform to be detected, in particular based on the characteristic values, and can select which region of the image recorded by the image detection device and, in particular, image recording device or thermal imaging camera is to be analyzed. It is also possible to control the image recording device itself, for example to zoom into a specific region.

It would be conceivable for the control device to have access to a memory device which stores which regions are to be advantageously inspected for specific characteristic values (or for certain plastics material preforms). The memory device can, for example, be an internal memory device.

However, it would also be possible for data to be stored or retrieved from a memory device that is, for example, a cloud (big data). For this purpose, it is possible that this higher-level memory device is, for example, filled with data from other machines, but also from the machine in question.

Two examples are given below: For example, a machine operator or a customer can move or process a large plastics material preform during a first production. During the production, this plastics material preform is inspected using the thermal imaging camera (for example, between the mentioned oven and a blow molding machine).

A predetermined region is recorded. If the operator wants to switch and run a smaller plastics material preform in a second production, the control device and/or the image recording device is informed of the geometry of this smaller plastics material preform and the regions that are to be inspected by the image recording device and/or those parts of the images recorded by the image recording device that are to be analyzed are determined.

In a second example, a customer or operator runs a plastics material preform with a first recycled content during a first production. Now, the plan is to switch and run plastics material preforms with a second recycled content in a second production. The control device can check in advance in the memory device whether a plastics material preform with this recycled content has already been run (on the machine in question or other machines). If a hit is found, the stored regions can be passed to the image recording device or thermal imaging camera. Preferably, the image recording and/or the image analysis can then be controlled accordingly.

In a further advantageous embodiment, the apparatus has a regulating device, in particular a control loop. In particular, the forming device can have a regulating device which also takes into account the recorded, spatially resolved temperatures of the plastics material preforms when regulating the forming device and, in particular, the individual forming stations.

Particularly preferably, the apparatus is used in conjunction with a forming device controlled by artificial intelligence. This means that the measured data from the image recording device are also incorporated into an AI-controlled control and/or regulation system.

In a further preferred method or a preferred apparatus, the heating device has at least one module which enables heating of the plastics material preform(s) that to varies in the circumferential direction of the plastics material preform. Such heating can be helpful if a forming device subsequently produces containers, which have a different cross-section, for example an oval cross-section. In this case, the detection device can detect warm or cold zones of the plastics material preform that deviate in the circumferential direction.

The invention achieves targeted inspection of critical regions of the plastics material preforms. Furthermore, improved container quality can be achieved. In addition, a faster and better machine setting is also possible. Furthermore, it is possible to reduce the reject rate. Furthermore, the invention offers the advantage of reduced or minimized startup effort.

Preferably, an image recording portion of the image recorded by the image recording device is selectable. For example, a specific portion of the plastics material preform in the circumferential direction can be selected, or a specific length range (and the image of this region or portion can be selected).

For example, it would be possible to record only a line or along a line (relative to the circumferential wall of the plastics material preform), which extends in parallel with the longitudinal direction of the plastics material preform. Furthermore, it would also be possible for one or several image recording portions to be recorded, which can preferably also be separate from one another.

In a preferred embodiment, it is possible for the plastics material preform to be unwound 360° during forward transport. During this movement, preferably at least 4, preferably at least 6, and preferably at least 8 images are recorded in the image region. Preferably not only vertical temperature information but preferably also horizontal information can thus be obtained (the latter may, for example, be relevant if the recyclate content is high).

Particularly preferably, these regions or image portions can be recorded independently of the position of the image recording device.

In a further embodiment, the apparatus has a detection device which is suitable and intended to detect a value characteristic of a plastics material preform.

Preferably, this value is selected from a group of values, which contains a length of the plastics material preform, an outer cross-section of the plastics material preform, an inner cross-section of the plastics material preform, a wall thickness of the plastics material preform, a material of the plastics material preform, a geometry of the plastics material preform, a recycled content of the material of the plastics material preform, a weight of the plastics material preform, the presence of additives in the material of the plastics material preform, a proportion of additives in the material of the plastics material preform, the type of additives in the material of the plastics material preform, and the like.

The detection device can be the image recording device itself. However, a detection device can also be provided in the form of an upstream device, such as a further image recording device or camera. Preferably, this further image recording device is an image recording device which is suitable and intended for recording images in the visible wavelength range. In addition, the detection device can also be an input device by which the user enters data.

In a preferred embodiment, the apparatus comprises a control device which controls the image recording device depending on the characteristic value. In particular, the control device selects the portion of a recorded image and/or controls the image recording device to select a specific portion of the recorded image.

Particularly preferably, the apparatus has a memory device which is suitable and intended to store links which assign control variables to characteristic values of the plastics material preforms, which control variables in turn can be fed to the control device. As mentioned above, a new plastics material preform can thus be detected and the memory device can be used to check whether certain values for controlling the image recording device and/or the analysis device have already been assigned to the plastics material preform.

For example, the memory device can store different types of plastics material preforms and their characteristic data, which have already been measured by the machine in question in the past or which have also been processed by other machines. For example, a data set of a plurality of plastics material preforms can be stored in the memory device.

The present invention is furthermore directed to a temperature detection device which is suitable and intended to detect a temperature of plastics material preforms heated by a heating device, wherein the temperature of the plastics material preforms can be acquired in a spatially resolved manner at least in a longitudinal direction of the plastics material preforms.

According to the invention, the temperature detection device has an image recording device which is suitable and intended to record a spatially resolved image of the plastics material preforms, wherein the image recording device is configurable and, preferably, is configurable taking into account at least one parameter characteristic of the plastics material preforms to be inspected.

It is therefore also proposed with reference to the temperature detection device that the temperature detection device is configurable in a specified manner and, in particular, is configurable with reference to the plastics material preform to be inspected, for example taking into account its length.

The present invention furthermore relates to a method for treating plastics material preforms, wherein a heating device heats the plastics material preforms, and wherein the heating device has a transport device which transports the plastics material preforms along a predetermined transport path, and at least one heating unit which heats the plastics material preforms transported by the transport device, and wherein a forming device which is arranged downstream of the heating device in a transport direction of the plastics material preforms forms the plastics material preforms heated by the heating device into plastics material containers, wherein the apparatus has at least one temperature detection device which detects a temperature of the plastics material preforms heated by the heating device, wherein the temperature of the plastics material preforms is detected in a spatially resolved manner at least in a longitudinal direction and/or a circumferential direction of the plastics material preforms.

According to the invention, the temperature detection device has an image recording device which records at least one spatially resolved image of the plastics material preforms, wherein the image recording device is configurable and/or is configured and, preferably, is configurable and/or is configured taking into account at least one parameter characteristic of the plastics material preforms to be inspected.

In particular, the image recording device is a thermal imaging camera, which preferably records a spatially resolved image of the plastics material preforms with regard to the temperature of the plastics material preforms.

The present invention is furthermore directed to a method for detecting a temperature of plastics material preforms, wherein a temperature detection device detects a temperature of plastics material preforms heated by a heating device, and wherein the temperature of the plastics material preforms is detected in a spatially resolved manner at least in a longitudinal direction and/or a circumferential direction of the plastics material preforms.

According to the invention, the temperature detection device has an image recording device which records a spatially resolved image of the plastics material preforms, wherein the image recording device is configured and, preferably, is configured taking into account at least one parameter characteristic of the plastics material preforms to be inspected.

Preferably, the plastics material preforms have a main body and a threaded portion arranged on this main body. Preferably, the plastics material preforms have a support ring on which the plastics material preforms can be supported.

Particularly preferably, the spatially resolved image is detected during a movement of the plastics material preform. However, the image is particularly preferably detected during a period of time in which the plastics material preform does not rotate or does not rotate significantly with respect to its longitudinal direction. Alternatively, rotation against the direction of movement could be carried out in order to reduce the movement during the recording.

In a further preferred method, a forming device is controlled taking into account the recorded image. In a further preferred embodiment, the heating device is also controlled taking into account the recorded image.

In a further preferred embodiment, both the forming device and the heating device are controllable and/or are controlled taking into account the at least one image.

Preferably, further parameters and/or measured values can be taken into account when controlling the forming device and/or the heating device. For example, the measured values of a light transmission measurement at the end of the forming device can be taken into account. Environmental parameters such as ambient temperature or humidity can also be taken into account.

In a further preferred method, at least one value characteristic of a physical property of the plastics material preform(s) is detected and, preferably, the image recording device is controlled taking into account this value. This can, for example, be a geometric property of the plastics material preform(s) (such as its length), as explained above.

Particularly preferably, at least one region of the image of a plastics material preform that is detected by the image recording device is selected and/or analyzed. Preferably, only a subregion of this image is analyzed.

In particular, a thermal analysis of the plastics material preform(s) is carried out depending on the selected image. In particular, an image or an image portion is selected depending on the physical property. For example, if a certain length of the plastics material preform is detected, the image portion can be selected depending on this detected length.

### BRIEF DESCRIPTION OF THE DRAWINGS

Further advantages and embodiments can be seen in the accompanying drawings, in which:

FIG. 1 shows a schematic representation of an apparatus according to the invention;

FIG. 2 shows a representation of a first operating situation;

FIG. 3 shows a representation of a second operating situation; and

FIG. 4 shows a representation of a third operating situation.

### DETAILED DESCRIPTION OF THE INVENTION

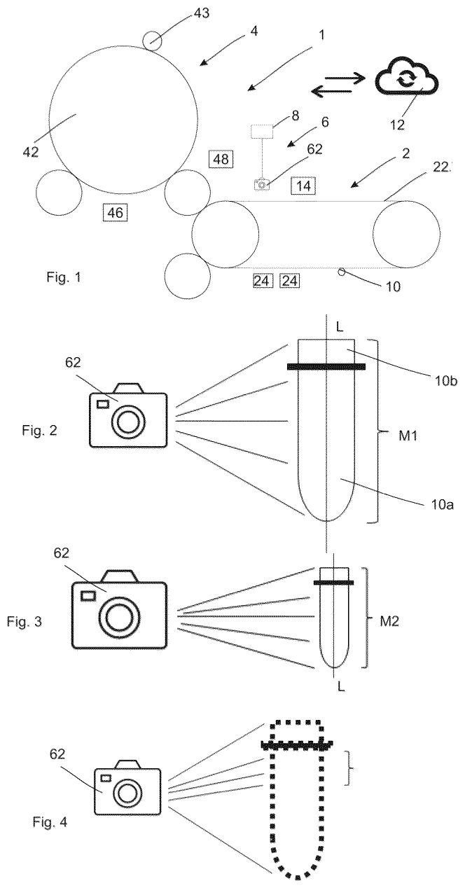

FIG. 1 shows a schematic representation of an apparatus 1 according to the invention. This apparatus has a heating device 2, here in the form of an infrared oven, which serves to heat the plastics material preforms 10.

For this purpose, the heating device 2 has a transport device 22, which serves to transport the plastics material preforms individually past heating units 24. These heating units are preferably arranged to be stationary.

The reference sign 4 designates a forming device for forming the heated plastics material preforms into plastics material containers and, in particular, plastics material bottles. This forming device 4 has a transport device 42, such as a blowing wheel, on which a plurality of forming stations 43 (only one shown) is arranged.

These forming stations each have blow molds, inside which the plastics material preforms are expanded into plastics material bottles by applying a flowable medium and, in particular, blowing air. Furthermore, the forming stations preferably each have stretching rods, which can be inserted into the plastics material preforms in order to stretch them in their longitudinal direction. In addition, the forming stations preferably each have valve devices, which make it possible to apply different pressure levels to the plastics material preforms.

The reference sign 46 designates a control device for controlling the forming device 4. Preferably, this control device makes it possible to control the individual forming stations 43 and/or the forming process. It is thus possible to control the application of the flowable medium to the plastics material preforms. In addition, it is however also possible that the movement of the mentioned stretching rods is controlled or controllable.

The reference sign 6 designates in its entirety a temperature detection device which is suitable and intended to detect the temperature of the plastics material preforms heated by the heating device. Preferably, this temperature detection is designed in such a way that it can measure and/or detect the temperature of each individual plastics material preform.

The temperature detection device has an image recording device 62, for example in the form of a thermal imaging camera, which is suitable for recording a thermal image of the plastics material preforms.

The reference sign 8 designates an analysis device which is suitable for analyzing the images recorded by the image recording device. Preferably, the image recording device and/or the analysis device is configurable. For example, it is, for example, possible to configure and/or control which part of the image recorded by the image recording device is to be analyzed.

Furthermore, a control device which controls the image recording by the image recording device 62 and/or the image analysis by the analysis device 8 is preferably provided.

The reference sign 48 schematically designates an assignment device, which assigns to the images recorded by the image recording device 62 those forming stations 43 which assign to those plastics material preforms whose temperature has been detected those forming stations which will form the corresponding plastics material preforms. In this way, individual forming of the plastics material preforms is possible depending on their temperature profile.

The reference sign 14 designates a further detection device, which is preferably arranged upstream of the temperature detection device 6 and which serves to detect the plastics material preforms and, for example, to detect their geometric shape. Preferably, this further detection device also has an image recording device which is suitable and intended to record a spatially resolved image of the individual transported plastics material preforms.

Preferably, this further detection device 14 is suitable and intended to output at least one value which is characteristic of the transported plastics material preforms.

Preferably, the image recording by the image recording device and/or the analysis of the recorded images is also controlled through the values output by the detection device.

The reference sign 12 designates a memory device in which reference data are stored, for example reference data with respect to the plastics material preforms to be processed.

If a plastics material preform is detected, it can be checked whether this plastics material preform corresponds to a plastics material preform stored in the memory device 12. In this case, the analysis device 8 can be instructed to analyze only a specific image region or the image recording device can be instructed to record a specific region.

FIG. 2 shows a first situation of the temperature detection. Here, the temperature of a first plastics material preform is measured, which has a first larger length M1. The reference sign L designates a longitudinal direction of the plastics material preforms. The reference sign 10a designates a main body (to be heated) of the plastics material preform, and the reference sign 10b designates a mouth region (not to be heated) of the plastics material preform.

The image recording device 62 (and, if applicable, the analysis device) are controlled in such a way that the temperature of the plastics material preform is recorded and/or analyzed over its entire length.

FIG. 3 shows a further measurement situation. Here, the plastics material preform is significantly shorter and only extends over the length M2. Accordingly, the image analysis and/or the image recording is also extended to the corresponding shorter region of the plastics material preform.

In the situation shown in FIG. 4, a plastics material preform which is made from a plastic material with recycled material content (as indicated by the dashed lines) is processed. In this case, too, the temperature detection can be adjusted. For example, the temperature can be detected with better resolution directly below the support ring of the plastics material preform.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. An apparatus for treating plastics material preforms with a heating device which is configured to heat the plastics material preforms, wherein the heating device has a transport device which transports the plastics material preforms along a predetermined transport path, and at least one heating unit which is configured to heat the plastics material preforms transported by the transport device, and with a forming device which is arranged downstream of the heating device in a transport direction of the plastics material preforms and which is configured to form the plastics material preforms heated by the heating device into plastics material containers, wherein the apparatus has at least one temperature detection device which is configured to detect a temperature of the plastics material preforms heated by the heating device, wherein the temperature of the plastics material preforms can be detected in a spatially resolved manner at least in a longitudinal direction and/or in a circumferential direction of the plastics material preforms,
wherein
the temperature detection device has an image recording device which is configured to record a spatially resolved image of the plastics material preforms, wherein the image recording device is configurable taking into account at least one parameter characteristic of the plastics material preforms to be inspected.

2. The apparatus according to claim 1,
wherein
the apparatus has a control device for controlling the forming device and this control device is configured to control the forming device depending on a temperature of a plastics material preform that is detected by the temperature detection device.

3. The apparatus according to claim 1,
wherein
the characteristic parameter is selected from a group of parameters, which contains a length of the plastics material preform, an outer cross-section of the plastics material preform, an inner cross-section of the plastics material preform, a wall thickness of the plastics material preform, a material and/or a material composition of the plastics material preform, a geometry of the plastics material preform, a recycled content of the material of the plastics material preform, a weight of the plastics material preform, the presence of additives in the material of the plastics material preform, a proportion of additives in the material of the plastics material preform, and the type of additives in the material of the plastics material preform.

4. The apparatus according to claim 1,
wherein
the image recording device is at least one thermal imaging camera.

5. The apparatus according to claim 1,
wherein
the apparatus has an analysis device which is configured to analyze the images recorded by the image recording device.

6. The apparatus according to claim 1,
wherein
an image recording portion of the image recorded by the image recording device is selectable.

7. The apparatus according to claim 1,
wherein
the apparatus has a detection device which is configured to detect at least the parameter characteristic of a plastics material preform.

8. The apparatus according to claim 1,
wherein
the apparatus has a control device configured to control the image recording device and/or the analysis device depending on the characteristic parameter.

9. The apparatus according to claim 1,
wherein
the apparatus has a memory device which is configured to store links which assign control variables to characteristic values of the plastics material preforms, which control variables can be fed to the control device.

10. A temperature detection device which is configured to detect a temperature of plastics material preforms heated by a heating device, wherein the temperature of the plastics material preforms can be detected in a spatially resolved manner at least in a longitudinal direction and/or a circumferential direction of the plastics material preforms,
wherein
the temperature detection device has an image recording device which is configured to record a spatially resolved image of the plastics material preforms, wherein the image recording device is configurable.

11. A method for treating plastics material preforms, wherein a heating device heats the plastics material preforms, and wherein the heating device has a transport device which transports the plastics material preforms along a predetermined transport path, and at least one heating unit which heats the plastics material preforms transported by the transport device, wherein a forming device which is arranged downstream of the heating device in a transport direction of the plastics material preforms forms the plastics material preforms heated by the warming device into plastics material containers, wherein the apparatus has at least one temperature detection device which detects a temperature of the plastics material preforms heated by the warming device, wherein the temperature of the plastics material preforms is detected in a spatially resolved manner at least in a longitudinal direction and/or a circumferential direction of the plastics material preforms,
wherein
the temperature detection device has an image recording device which records at least one spatially resolved image of the plastics material preforms.

12. A method for detecting a temperature of plastics material preforms, wherein a temperature detection device detects a temperature of plastics material preforms heated by a heating device, and wherein the temperature of the plastics material preforms is detected in a spatially resolved manner at least in a longitudinal direction and/or a circumferential direction of the plastics material preforms,
wherein
the temperature detection device has an image recording device which records a spatially resolved image of the plastics material preforms, wherein the image recording device is configured.

13. The method according to claim 11,
wherein
at least one parameter characteristic of a physical property of the plastics material preform is detected.

14. The method according to claim 11,
wherein
at least one image of the image of a plastics material preform that is detected by the image recording device is selected.

15. The method according to claim 12,
wherein
at least one parameter characteristic of a physical property of the plastics material preform is detected.

16. The method according to claim 12,
wherein
at least one image of the image of a plastics material preform that is detected by the image recording device is selected.
